(19) United States
(12) Patent Application Publication
(10) Pub. No.: US 2021/0070967 A1
(43) Pub. Date: Mar. 11, 2021

(54) RUBBER COMPOSITION FOR TIRE AND PNEUMATIC TIRE

(71) Applicant: Toyo Tire Corporation, Itami-shi, Hyogo (JP)

(72) Inventor: Fumihiko Nakamura, Itami-shi (JP)

(73) Assignee: Toyo Tire Corporation, Itami-shi, Hyogo (JP)

(21) Appl. No.: 16/771,766

(22) PCT Filed: Jan. 28, 2019
(86) PCT No.: PCT/JP2019/002693

§ 371 Date: Jun. 11, 2020

(30) Foreign Application Priority Data
Jan. 31, 2018 (JP) 2018-014626
Jan. 31, 2018 (JP) 2018-014630
Jan. 31, 2018 (JP) 2018-014633

(51) Int. Cl. C08L 9/06; B60C 1/00; B60C 11/00

(52) U.S. Cl. CPC C08L 9/06; C08L 2205/035; B60C 11/0008; B60C 1/0016

(57) ABSTRACT

A rubber composition for a tire which comprises a rubber component comprising diene rubber, silica and an ether ester represented by the following formula (1):

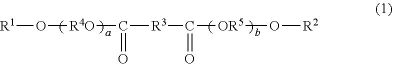

wherein R¹ and R² each independently represent a hydrocarbon group having from 8 to 30 carbon atoms, R³ represents a hydrocarbon group having from 1 to 30 carbon atoms, R⁴ and R⁵ each independently represent an alkylene group having from 2 to 4 carbon atoms, a and b each independently represent the average number of moles added of oxyalkylene groups, and 60 mass % or more of (R⁴O)ₐ and (OR⁵)_{b} comprises an oxyethylene group, is disclosed. Furthermore, a pneumatic tire manufactured using the rubber composition is disclosed.

### TECHNICAL FIELD

The present invention relates to a rubber composition for a tire and a pneumatic tire using the same.

### BACKGROUND ART

It is known that silica is used as a filler in a rubber composition for tires since it has excellent effects in both low rolling resistance and grip performance on wet road surface (wet grip performance). However, silica is easy to be coagulated by silanol groups present on the surface of its particle. In particular, when silica has been added in a large amount in order to further improve effects in both low rolling resistance and wet grip performance, a viscosity of a rubber composition is increased during kneading, and this leads to deterioration of processability.

Furthermore, a rubber composition for tires is sometimes required to improve abrasion resistance. However, it is difficult to improve both processability and abrasion resistance in a rubber composition for tires having added thereto a large amount of silica.

On the other hand, a rubber composition for tires is sometimes required to improve steering stability together with the improvement of abrasion resistance. However, the conventional rubber composition needs further improvement in that abrasion resistance and steering stability are improved without deteriorating low rolling resistance.

A rubber composition for tires is required to improve abrasion resistance, and additionally, for example, a rubber composition for all-season tires is sometimes required to have snow performance (running performance on snowy road) in order to enable to run on snowy road. However, the conventional rubber composition needs further improvement in that abrasion resistance and snow performance are improved without deteriorating low rolling resistance.

Patent Literatures 1 and 2 propose adding glycerin monofatty acid ester in order to improve dispersibility of silica. Patent Literature 3 proposes adding nonionic surfactant comprising polyethylene glycol monofatty acid ester and/or polyethylene glycol difatty acid ester in order to improve appearance of tires while maintaining or improving low fuel consumption and abrasion resistance. Patent Literature 4 proposes concurrently using polyoxyethylene hydrogenated castor oil and polyoxyethylene glycerin trifatty acid ester as a dispersant of silica. However, it is not known that processability, abrasion resistance, steering stability, snow performance and the like can be improved by using an ester of polyoxyalkylene alkyl ether and dicarboxylic acid.

### CITATION LIST

### Patent Literature

Patent Literature 1: JP-A-2016-113602

Patent Literature 2: JP-A-2016-113515

Patent Literature 3: JP-A-2015-000972

Patent Literature 4: JP-A-2014-210829

### SUMMARY OF INVENTION

### Technical Problem

A first embodiment of the present invention has an object to provide a rubber composition for a tire that can improve processability and abrasion resistance in a silica-added rubber composition.

A second embodiment of the present invention has an object to provide a rubber composition for a tire that can improve abrasion resistance and steering stability without deteriorating low rolling resistance in a silica-added rubber composition.

A third embodiment of the present invention has an object to provide a rubber composition for a tire that can improve abrasion resistance and snow performance without deteriorating low rolling resistance in a silica-added rubber composition.

### Solution to Problem

A rubber composition for a tire according to a first embodiment of the present invention comprises a rubber component comprising diene rubber, silica and an ether ester represented by the following general formula (1).

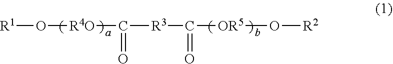

In the formula, R¹ and R² each independently represent a hydrocarbon group having from 8 to 30 carbon atoms, R³ represents a hydrocarbon group having from 1 to 30 carbon atoms, R⁴ and R⁵ each independently represent an alkylene group having from 2 to 4 carbon atoms, a and b each independently represent the average number of moles of oxyalkylene groups added, and 60 mass % or more of (R⁴O)ₐ and (OR⁵)_{b} comprises an oxyethylene group.

A rubber composition for a tire according to a second embodiment comprises a rubber component containing styrene-butadiene rubber having a glass transition temperature of from −70 to −20° C., silica and the ether ester represented by the above general formula (1).

A rubber composition for a tire according to a third embodiment comprises a rubber component comprising styrene-butadiene rubber having a glass transition temperature of from −70 to −20° C. and butadiene rubber, silica and the ether ester represented by the above general formula (1).

The pneumatic tire according to the embodiment of the present invention has a rubber part comprising the rubber composition.

### Advantageous Effects of Invention

According to the first embodiment, processability and abrasion resistance of a silica-added rubber composition can be improved by adding the ether ester.

According to the second embodiment, abrasion resistance and steering stability can be improved without deteriorating low rolling resistance in a silica-added rubber composition by using specific styrene-butadiene rubber as a rubber component and additionally adding the ether ester.

According to the third embodiment, abrasion resistance and snow performance can be improved without deteriorating low rolling resistance in a silica-added rubber composition by adding the ether ester together with the specific rubber component.

### MODE FOR CARRYING OUT THE INVENTION

### First Embodiment

The rubber composition according to this embodiment comprises a rubber component comprising diene rubber, having added thereto silica and a specific ether ester.

The diene rubber as the rubber component is not particularly limited, and includes various diene rubbers generally used in a rubber composition, such as natural rubber, (NR), synthetic isoprene rubber (IR), butadiene rubber (that is, polybutadiene rubber, BR), styrene-butadiene rubber (SBR), nitrile rubber (NBR), chloroprene rubber (CR), butyl rubber (IIR), styrene-isoprene copolymer rubber, butadiene-isoprene copolymer rubber and styrene-isoprene-butadiene copolymer rubber. Those diene rubbers can be used in one kind alone or as a mixture of two or more kinds.

The rubber component according to the preferred one embodiment contains at least one selected from the group consisting of styrene-butadiene rubber, butadiene rubber and natural rubber. The rubber component more preferably contains at least styrene-butadiene rubber and still more preferably contains styrene-butadiene rubber and butadiene rubber. For example, 100 parts by mass of the rubber component may contain from 50 to 100 parts by mass of styrene-butadiene rubber, from 0 to 50 parts by mass of butadiene rubber and from 0 to 50 parts by mass of natural rubber, may contain from 50 to 90 parts by mass of styrene-butadiene rubber and from 10 to 50 parts by mass of butadiene rubber and may contain from 60 to 85 parts by mass of styrene-butadiene rubber and from 15 to 40 parts by mass of butadiene rubber.

Silica as a filler is not particularly limited. For example, wet silica such as wet precipitated silica or wet gel process silica may be used. BET specific surface area of silica (measured according to BET method described in JIS K6430) of the silica is not particularly limited, and for example, may be from 100 to 300 m²/g and may be from 150 to 250 m²/g.

The amount of the silica added is not particularly limited. The amount may be from 20 to 120 parts by mass, may be from 40 to 120 parts by mass, may be from 50 to 120 parts by mass and may be from 70 to 120 parts by mass, per 100 parts by mass of the rubber component. In this embodiment, silica is preferably used as a main filler. That is, more than 50 mass % of the filler is preferably silica. More preferably, more than 70 mass % of the filler is silica.

Silica may be used alone as the filler, but carbon black may be added together with silica. The carbon black is not particularly limited, and conventional various kinds can be used. For example, in the case of using in a tire tread rubber, SAF grade (N100 series), ISAF grade (N200 Series), HAF grade (N300 Series) and FEF grade (N500 Series) (those are ASTM grade) are preferably used. Carbon blacks of each grade can be used in one kind or as mixture of two or more kinds. The amount of the carbon black added is not particularly limited. The amount may be 20 parts by mass or less and may be from 5 to 15 parts by mass, per 100 parts by mass of the rubber component.

An ether ester represented by the following general formula (1) is added to the rubber composition of this embodiment. The ether ester is dicarboxylic acid diester having polyoxyalkylene. It is considered that coagulation of silica can be suppressed by adsorbing the polyoxyalkylene moiety on the surface of silica. As a result, the increase in viscosity during kneading is suppressed. Furthermore, it is considered that affinity for the diene rubber is improved by the hydrocarbon groups at both ends and flexibility of the rubber is improved. Thus, as a result that the ether ester acts to both the diene rubber and silica, abrasion resistance can be improved, differing from a processing aid such metallic soap. Furthermore, the effect of improving tear resistance is developed as shown in the examples described hereinafter.

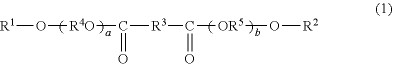

In the formula (1), R¹ and R² each independently represent a monovalent hydrocarbon group having from 8 to 30 carbon atoms. The number of carbon atoms of the hydrocarbon group is more preferably from 10 to 24 and still more preferably from 12 to 20. The hydrocarbon group is preferably a linear or branched saturated or unsaturated aliphatic hydrocarbon group, and for example, an alkyl group or an alkenyl group is preferred.

In the formula (1), R³ represents a divalent hydrocarbon group having from 1 to 30 carbon atoms. The number of carbon atoms of the hydrocarbon group is more preferably from 1 to 20 and still more preferably from 2 to 10, and may be from 2 to 8. The divalent hydrocarbon group may be a linear or branched saturated or unsaturated aliphatic hydrocarbon group and may be an aromatic hydrocarbon group. For example, a linear or branched alkanediyl group, a linear or branched alkenediyl group and a phenylene group which may have a substituent (for example, an alkyl group and/or an alkenyl group) are exemplified. R³ is a moiety formed by excluding carboxy groups from a dicarboxylic acid. The dicarboxylic acid includes saturated aliphatic dicarboxylic acid such as maloic acid, succinic acid, glutaric acid, adipic acid, pimelic acid, suberic acid, azelaic acid or sebacic acid, unsaturated aliphatic dicarboxylic acid such as maleic acid, fumaric acid, citraconic acid, mesaconic acid, itaconic acid, allylmaloic acid or 2,4-hexadiene diacid, and aromatic dicarboxylic acid such as phthalic acid, isophthalic acid or terephthalic acid.

In the formula (1), R⁴ and R⁵ each independently represent an alkylene group having from 2 to 4 carbon atoms, and a and b each independently represent the average number of moles of oxyalkylene groups added. More preferably, R⁴ and R⁵ each independently represent an alkylene group having 2 or 3 carbon atoms. The alkylene group of R⁴ and R⁵ may be straight chain and may be branched chain. The oxyalkylene group represented by R⁴O and R⁵O includes an oxyethylene group, an oxypropylene group and an oxybutylene group, respectively. (R⁴O)ₐ and (OR⁵)_{b} in the formula (1) are each a polyoxyalkylene chain obtained by addition polymerizing alkylene oxide having from 2 to 4 carbon atoms (for example, ethylene oxide, propylene oxide or butylene oxide). The polymerization form of the alkylene oxide and the like is not particularly limited, and the polymer may be a homopolymer, may be a random copolymer and may be a block copolymer.

The (R⁴O)ₐ and (OR⁵)_{b} in the formula (1) preferably comprise mainly an oxyethylene group, and 60 mass % or more of (R⁴O)ₐ and (OR⁵)_{b} preferably comprises an oxyethylene group. In other words, the polyoxyalkylene chain represented by (R⁴O)ₐ and the polyoxyalkylene chain represented by (R⁵O)_{b} contain an oxyethylene group in an amount of preferably 60 mass % or more and more preferably 80 mass % or more, based on the total amount of those chains. Particularly preferably, those chains comprise 100 mass % of the oxyethylene group, that is, comprises only the oxyethylene group as shown in the following formula (2). As one embodiment, The (R⁴O)ₐ and (OR⁵)_{b} each comprise 60 mass % or more of the oxyethylene group.

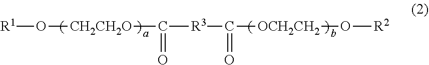

R¹, R², R³, a and b in the formula (2) are the same as R¹, R², R³, a and b in the formula (1).

The a and b showing the average number of moles of oxyalkylene groups added are each preferably 1 or more, and the total of a and b, that is, a+b, may be from 1 to 30, may be from 2 to 25 and may be from 3 to 20.

The HLB (hydrophilic-lipophilic balance) of the ether ester is not particularly limited, and, for example, may be from 3 to 15, may be from 4 to 14 and may be from 5 to 12. The HLB used herein is a value calculated by the following Griffin's formula. The proportion of hydrophilic moiety occupied in the whole molecules is large as the value is large, and this indicates that hydrophilicity is high.

HLB=20×(molecular weight of hydrophilic moiety)/(whole molecular weight)

The molecular weight of the hydrophilic moiety in the formula is a molecular weight of polyoxyalkylene chains represented by (R⁴O)ₐ and (OR⁵)_{b}.

The amount of the ether ester added is not particularly limited, but is preferably from 1 to 10 parts by mass and more preferably from 2 to 8 parts by mass, per 100 parts by mass of the rubber component. When the amount of the ether ester added is too large, processability is good, but the improvement effect of abrasion resistance and tear resistance tend to be decreased. For this reason, the amount of the ether ester added is preferably 10 parts by mass or less.

Other than the above components, various additives generally used in a rubber composition, such as a silane coupling agent, oil, zinc flower, stearic acid, an age resister, a wax, a vulcanizing agent and vulcanization accelerator, can be added to the rubber composition according to this embodiment.

The silane coupling agent includes sulfide silane, mercaptosilane and the like. The amount of the silane coupling agent added is not particularly limited, but is preferably from 2 to 20 mass % based on the amount of the silica added.

Sulfur is preferably used as the vulcanizing agent. The amount of the vulcanizing agent added is not particularly limited, but is preferably from 0.1 to 10 parts by mass and more preferably from 0.5 to 5 parts by mass, per 100 parts by mass of the rubber component. The vulcanization accelerator includes various vulcanization accelerators such as sulfenamide type, thiuram type, thiazole type and guanidine type, and those can be used in one kind alone or by combining two or more kinds. The amount of the vulcanization accelerator added is not particularly limited, but is preferably from 0.1 to 7 parts by mass and more preferably from 0.5 to 5 parts by mass, per 100 parts by mass of the rubber component.

The rubber composition according to this embodiment can be prepared by kneading the necessary components according to the conventional methods using a mixing machine generally used, such as Banbury mixer, a kneader or rolls. In other words, for example, additives other than a vulcanizing agent and a vulcanization accelerator are added to the rubber component together with silica and the ether ester, followed by mixing, in a first mixing step (non-productive mixing step). A vulcanizing agent and a vulcanization accelerator are then added to the mixture thus obtained, followed by mixing, in a final mixing step (productive mixing step). Thus, an unvulcanized rubber composition can be prepared.

The rubber composition according to this embodiment can be used as a rubber composition for tires. The tires include pneumatic tires having various uses and various sizes, such as tires for passenger cars or for heavy load of trucks or buses.

The pneumatic tire according to one embodiment is manufactured using the rubber composition. That is, the pneumatic tire is equipped with a rubber part comprising the rubber composition. The part of the tire to which the rubber composition is applied includes tread rubber and sidewall rubber, for example, and the rubber composition is preferably used in tread rubber. The tread rubber of a pneumatic tire includes a tread rubber comprising a two-layered structure of a cap rubber and a base rubber, and a single layer structure in which those are integrated. In this embodiment, the rubber composition is preferably used in a rubber constituting a ground contact surface. That is, it is preferred that when the tread rubber has a single layer structure, the tread rubber preferably comprises the rubber composition mentioned above, and when the tread rubber has a two-layered structure, the cap rubber preferably comprises the rubber composition mentioned above.

A method for manufacturing a pneumatic tire is not particularly limited. For example, the rubber composition is molded into a predetermined shape by extrusion according to the conventional method, and is combined with other members to prepare an unvulcanized rubber (green tire). For example, a tread rubber is prepared using the rubber composition, and the tread rubber is combined with other tire members to prepare an unvulcanized tire. Thereafter, the unvulcanized tire is vulcanization molded at a temperature of, for example, from 140 to 180° C. Thus, a pneumatic tire can be manufactured.

### Second Embodiment

The rubber composition according to the second embodiment is common to the first embodiment in that silica and the specific ether ester are added to the rubber component comprising diene rubber.

The second embodiment is characterized in that the rubber component contains styrene-butadiene rubber (SBR) having a glass transition temperature (Tg) of from −70 to −20° C. By using the styrene-butadiene rubber having such a glass transition temperature together with the ether ester, abrasion resistance can be improved while suppressing deterioration of low rolling resistance. The glass transition temperature of the styrene-butadiene rubber is more preferably from −50 to −25° C. In the present description, the glass transition temperature is a value measured in a temperature rising rate: 20° C./min (measurement temperature range: from −150 to 50° C.) by a differential scanning calorimetry (DSC) according to JIS K7121.

The SBR having Tg of from −70 to −20° C. may be solution-polymerized SBR (SSBR), may be emulsion-polymerized SBR (ESBR), may be modified SBR and may be unmodified SBR.

SBR having a functional group containing oxygen atom and/or nitrogen atom incorporated therein is exemplified as the modified SBR. The modified SBR has high polarity as compared with unmodified SBR, and therefore can improve interaction with silica and the ether ester.

At least one selected from the group consisting of an amino group, an alkoxyl group, a hydroxy group, an epoxy group, a carboxy group and a carboxylic acid derivative group is exemplified as the functional group of the modified SBR. The amino group may be not only a primary amino group, but may be a secondary or tertiary amino group. In the case of a secondary or tertiary amino group, the number of carbon atoms of the hydrocarbon group as a substituent is preferably 15 or less in total. As the alkoxyl group, a methoxy group, an ethoxy group, a propoxy group, butoxy group and the like that are represented by —OA (wherein A is, for example, an alkyl group having from 1 to 4 carbon atoms) are exemplified. Furthermore, the alkoxyl group may be contained as an alkoxysilyl group (at least one of three hydrogens of a silyl group is substituted with an alkoxyl group) such as a trialkoxysilyl group, an alkyl dialkoxysilyl group or a dialkyl alkoxysilyl group. As the carboxylic acid derivative group, an ester group derived from carboxylic acid (carboxylic acid ester group) and an acid anhydride group comprising an anhydride of dicarboxylic acid such as maleic acid or phthalic acid are exemplified. As the carboxylic acid ester group, for example, an acrylate group (—O—CO—CH═CH₂) and/or a methacrylate group (—O—CO—C(CH₃)═CH₂) (hereinafter referred to as a (meth)acrylate group) are exemplified. As one embodiment, the functional group of the modified SBR may be at least one selected from the group consisting of an amino group, an alkoxyl group and a hydroxy group. Those functional groups may be incorporated in at least one end of a polymer molecular chain, or may be incorporated in a molecular chain.

The rubber component may be constituted of only the aforementioned SBR having Tg of from −70 to −20° C., but, for example, other diene rubbers such as natural rubber (NR), synthetic isoprene rubber (IR), butadiene rubber (BR), styrene-isoprene rubber, butadiene-isoprene rubber and styrene-butadiene-isoprene rubber may be used in one kind or as a mixture of two or more kinds.

The rubber component according to the preferred one embodiment is SBR having Tg of from −70 to −20° C. alone or a combination of SBR having Tg of from −70 to −20° C., and NR and/or IR. For example, 100 parts by mass of the rubber component may be constituted of from 50 to 100 parts by mass of SBR having Tg of from −70 to −20° C., and from 0 to 50 parts by mass of NR and/or IR, and may be constituted of from 60 to 100 parts by mass of SBR having Tg of from −70 to −20° C., and from 0 to 40 parts by mass of NR and/or IR. The SBR having Tg of from −70 to −20° C. may be that 50 mass % or more thereof is constituted of modified SBR.

In the second embodiment, the amount of silica added as a filler is not particularly limited. The amount may be from 20 to 120 parts by mass, may be from 40 to 120 parts by mass and may be from 50 to 100 parts by mass, per 100 parts by mass of the rubber component. The amount of carbon black added that can be used together with silica is not particularly limited. The amount may be from 1 to 70 parts by mass, may be from 1 to 50 parts by mass and may be from 5 to 40 parts by mass, per 100 parts by mass of the rubber component. Other constituents of the filler are the same as in the first embodiment.

The ether ester represented by the general formula (1) is added to the rubber composition according to the second embodiment. It is considered that coagulation of silica is suppressed by adsorbing a polyoxyalkylene moiety of the ether ester on the surface of silica. Furthermore, it is considered that affinity for the rubber component is improved by hydrocarbon groups at both ends. By that the ether ester acts to both the rubber component and silica, it is considered that abrasion resistance and steering stability can be improved without deteriorating low rolling resistance coupled with the use of the specific SBR as the rubber component. Other constitutions of the ether ester are the same as in the first embodiment.

The rubber composition according to the second embodiment can be used in pneumatic tires having various uses and various sizes, such as tires for passenger cars and tires for heavy load of trucks and buses. In particular, the rubber composition has excellent steering stability on dry road surface, and therefore is suitably used as a rubber composition for summer tires. In other words, the pneumatic tire according to the preferred one embodiment is a summer tire.

Other constitutions in the second embodiment are the same as in the first embodiment and can adopt the same constitutions as in the first embodiment.

### Third Embodiment

The rubber composition according to the third embodiment is common to the first embodiment in that silica and the specific ether ester are added to the rubber component comprising diene rubber.

The third embodiment is characterized in that the rubber component contains styrene-butadiene rubber (SBR) having a glass transition temperature (Tg) of from −70 to −20° C. and butadiene rubber (BR). By using the styrene-butadiene rubber having such a glass transition temperature together with the butadiene rubber as the rubber component and additionally adding the ether ester, abrasion resistance can be improved while suppressing deterioration of low rolling resistance. The glass transition temperature of the styrene-butadiene rubber is more preferably −70° C. or more and less than −50° C. and more preferably from −70 to −60° C.

SBR having Tg of from −70 to −20° C. may be solution-polymerized SBR (SSBR), may be emulsion-polymerized SBR (ESBR), may be modified SBR and may be unmodified SBR. SBR having a functional group containing oxygen atom and/or nitrogen atom incorporated therein is exemplified as the modified SBR. For example, SBR having at least one functional group selected from the group consisting of an amino group, an alkoxyl group, a hydroxy group, an epoxy group, a carboxy group and a carboxylic acid derivative group incorporated therein is exemplified as the modified SBR. The details of the modified SBR are the same as described in the second embodiment.

The butadiene rubber is not particularly limited, and various polybutadiene rubbers generally used in a rubber composition for tires can be used. For example, high cis-polybutadiene having cis-1,4 bond content of 90 mass % or more may be used as the butadiene rubber.

The rubber component may be constituted of only the aforementioned SBR having Tg of from −70 to −20° C. and BR, but, for example, other diene rubbers such as natural rubber (NR), synthetic isoprene rubber (IR), styrene-isoprene rubber, butadiene-isoprene rubber and styrene-butadiene-isoprene rubber may be used in one kind or as a mixture of two or more kinds.

The rubber component according to the preferred one embodiment includes a combination of SBR having Tg of from −70 to −20° C. and BR, and a combination of SBR having Tg of from −70 to −20° C., BR, and NR and/or IR. For example, 100 parts by mass of the rubber component may be constituted of from 40 to 70 parts by mass of SBR having Tg of from −70 to −20° C., from 20 to 50 parts by mass of BR and from 0 to 30 parts by mass of NR and/or IR, and may be constituted of from 45 to 65 parts by mass of SBR having Tg of from −70 to −20° C., from 30 to 45 parts by mass of BR and from 0 to 20 parts by mass of NR and/or IR.

In the third embodiment, the amount of silica added as a filler is not particularly limited. The amount may be from 20 to 120 parts by mass, may be from 40 to 100 parts by mass and may be from 50 to 90 parts by mass, per 100 parts by mass of the rubber component. In this embodiment, silica is preferably used as a main filler. Specifically, preferably 50 mass % or more of the filler is silica, and more preferably more than 70 mass % of the filler is silica. The amount of carbon black added that can be used together with silica is not particularly limited. The amount may be from 1 to 70 parts by mass, may be from 1 to 50 parts by mass and may be from 5 to 40 parts by mass, per 100 parts by mass of the rubber component. Other constitutions of the filler are the same as in the first embodiment.

The ether ester represented by the general formula (1) is added to the rubber composition according to the third embodiment. It is considered that coagulation of silica is suppressed by adsorbing a polyoxyalkylene moiety of the ether ester on the surface of silica. Furthermore, it is considered that affinity for the rubber component is improved by hydrocarbon groups at both ends. By that the ether ester acts to both the rubber component and silica, it is considered that abrasion resistance can be improved without deteriorating low rolling resistance coupled with the use of the specific rubber component. Furthermore, it is considered that by adding the ether ester, change in hardness at low temperature is small and as a result, snow performance can be improved. Other constitutions of the ether ester are the same as in the first embodiment.

The rubber composition according to the third embodiment can be used in pneumatic tires having various uses and various sizes, such as tires for passenger cars and tires for heavy load of trucks and buses. In particular, the rubber composition has excellent snow performance, and therefore is suitably used as a rubber composition for all season tires. In other words, the pneumatic tire according to the preferred one embodiment is an all-season tire.

Other constitutions in the third embodiment are the same as in the first embodiment and can adopt the same constitutions as in the first embodiment.

### EXAMPLES

Examples are described below, but the invention is not construed as being limited to those examples.

[Synthesis of Ether Ester]

Ether esters A to H used in the examples and comparative examples were synthesized by the following methods.

[Ether Ester A]

0.1 g of a potassium hydroxide catalyst was added to 67 g (0.25 mol) of oleyl alcohol (manufactured by Tokyo Chemical Industry Co., Ltd.), 55 g (1.25 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 92 g (yield 75 mass %) of an adduct of oleyl alcohol with 5 mol of ethylene oxide was obtained. The above procedures were followed, except that 61 g (0.25 mol) of cetyl alcohol (manufactured by Tokyo Chemical Industry Co., Ltd.) was used in place of oleyl alcohol, and 87 g (yield 75 mass %) of an adduct of cetyl alcohol with 5 mol of ethylene oxide was obtained. Maleic dichloride was dissolved in dichloromethane solvent at 0° C., and 1 molar equivalent of each of two compounds obtained by the addition polymerization was added to the resulting solution in the presence of triethylamine catalyst. Thereafter, the resulting mixture was stirred at room temperature for 5 hours. Thus, ether ester A was obtained. The ether ester A is an ether ester of the formula (2) wherein R¹ and R²: oleyl group (C₁₈H₃₅) and cetyl group (C₁₆H₃₃), R³: C₂H₂, a+b=10 and HLB=8.5.

[Ether Ester B]

0.1 g of a potassium hydroxide catalyst was added to 50 g (0.25 mol) of tridecyl alcohol (manufactured by Tokyo Chemical Industry Co., Ltd.), 28 g (0.625 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 70 g (yield 90 mass %) of an adduct of tridecyl alcohol with 2.5 mol of ethylene oxide was obtained. Maleic dichloride was dissolved in dichloromethane solvent at 0° C., and 2 molar equivalents of the compound obtained by the addition polymerization were added to the resulting solution in the presence of triethylamine catalyst. Thereafter, the resulting mixture was stirred at room temperature for 5 hours. Thus, ether ester B was obtained. The ether ester B is an ether ester of the formula (2) wherein R¹ and R²: tridecyl group (C₁₃H₂₇), R³: C₂H₂, a+b=5 and HLB=6.

[Ether Ester C]

0.1 g of a potassium hydroxide catalyst was added to 50 g (0.25 mol) of tridecyl alcohol (manufactured by Tokyo Chemical Industry Co., Ltd.), 50 g (1.125 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 86 g (yield 87 mass %) of an adduct of tridecyl alcohol with 4.5 mol of ethylene oxide was obtained. Maleic dichloride was dissolved in dichloromethane solvent at 0° C., and 2 molar equivalents of the compound obtained by the addition polymerization were added to the resulting solution in the presence of triethylamine catalyst. Thereafter, the resulting mixture was stirred at room temperature for 5 hours. Thus, ether ester C was obtained. The ether ester C is an ether ester of the formula (2) wherein R¹ and R²: tridecyl group (C₁₃H₂₇), R³: C₂H₂, a+b=9 and HLB=9.

[Ether Ester D]

0.1 g of a potassium hydroxide catalyst was added to 50 g (0.25 mol) of tridecyl alcohol (manufactured by Tokyo Chemical Industry Co., Ltd.), 72 g (1.625 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 101 g (yield 83 mass %) of an adduct of tridecyl alcohol with 6.5 mol of ethylene oxide was obtained. Maleic dichloride was dissolved in dichloromethane solvent at 0° C., and 2 molar equivalents of the compound obtained by the addition polymerization were added to the resulting solution in the presence of triethylamine catalyst. Thereafter, the resulting mixture was stirred at room temperature for 5 hours. Thus, ether ester D was obtained. The ether ester D is an ether ester of the formula (2) wherein R¹ and R²: tridecyl group (C₁₃H₂₇), R³: C₂H₂, a+b=13 and HLB=11.

[Ether Ester E]

0.1 g of a potassium hydroxide catalyst was added to 47 g (0.25 mol) of lauryl alcohol (manufactured by Tokyo Chemical Industry Co., Ltd.), 50 g (1.125 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 108 g (yield 92 mass %) of an adduct of lauryl alcohol with 4.5 mol of ethylene oxide was obtained. Maleic dichloride was dissolved in dichloromethane solvent at 0° C., and 2 molar equivalents of the compound obtained by the addition polymerization were added to the resulting solution in the presence of triethylamine catalyst. Thereafter, the resulting mixture was stirred at room temperature for 5 hours. Thus, ether ester E was obtained. The ether ester E is an ether ester of the formula (2) wherein R¹ and R²: lauryl group (C₁₂H₂₅), R³: C₂H₂, a+b=9 and HLB=9.5.

[Ether Ester F]

0.1 g of a potassium hydroxide catalyst was added to 67 g (0.25 mol) of oleyl alcohol (manufactured by Tokyo Chemical Industry Co., Ltd.), 50 g (1.125 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 93 g (yield 80 mass %) of an adduct of oleyl alcohol with 4.5 mol of ethylene oxide was obtained. The above procedures were followed, except that 61 g (0.25 mol) of cetyl alcohol (manufactured by Tokyo Chemical Industry Co., Ltd.) was used in place of oleyl alcohol, and 88 g (yield 80 mass %) of an adduct of cetyl alcohol with 4.5 mol of ethylene oxide was obtained. Adipic dichloride was dissolved in dichloromethane solvent at 0° C., and 1 molar equivalent of each of two compounds obtained by the addition polymerization was added to the resulting solution in the presence of triethylamine catalyst. Thereafter, the resulting mixture was stirred at room temperature for 5 hours. Thus, ether ester F was obtained. The ether ester F is an ether ester of the formula (2) wherein R¹ and R²: oleyl group (C₁₈H₃₅) and cetyl group (C₁₆H₃₃), R³: C₄H₈, a+b=9 and HLB=8.

[Ether Ester G]

0.1 g of a potassium hydroxide catalyst was added to 50 g (0.25 mol) of tridecyl alcohol (manufactured by Tokyo Chemical Industry Co., Ltd.), 55 g (1.25 mol) of ethylene oxide (manufactured by Tokyo Chemical Industry Co., Ltd.) was injected in the resulting mixture while stiffing at a temperature of from 110 to 120° C., and addition reaction was conducted. The reactant was transferred to a flask, and potassium hydroxide as a catalyst was neutralized with phosphoric acid. A phosphate was filtered out from the neutralized material, and 85 g (yield 81 mass %) of an adduct of tridecyl alcohol with 5 mol of ethylene oxide was obtained. Adipic dichloride was dissolved in dichloromethane solvent at 0° C., and 2 molar equivalents of the compound obtained by the addition polymerization were added to the resulting solution in the presence of triethylamine catalyst. Thereafter, the resulting mixture was stirred at room temperature for 5 hours. Thus, ether ester G was obtained. The ether ester G is an ether ester of the formula (2) wherein R¹ and R²: tridecyl group (C₁₃H₂₇), R³: C₄H₈, a+b=10 and HLB=9.5.

[Ether Ester H]

0.1 g of a potassium hydroxide catalyst was added to 67 g (0.25 mol) of oleyl alcohol (manufactured by Tokyo Chemical Industry Co., Ltd.), 55 g (1.25 mol) of ethylene oxide (manufactured by Tokyo Chemical Industry Co., Ltd.) was injected in the resulting mixture while stirring at a temperature of from 110 to 120° C., and addition reaction was conducted. The reactant was transferred to a flask, and potassium hydroxide as a catalyst was neutralized with phosphoric acid. A phosphate was filtered out from the neutralized material, and 92 g (yield 75 mass %) of an adduct of oleyl alcohol with 5 mol of ethylene oxide was obtained. The above procedures were followed, except that 61 g (0.25 mol) of cetyl alcohol (manufactured by Tokyo Chemical Industry Co., Ltd.) was used in place of oleyl alcohol, and 87 g (yield 75 mass %) of an adduct of cetyl alcohol with 5 mol of ethylene oxide was obtained. Itaconic dichloride was dissolved in dichloromethane solvent at 0° C., and 1 molar equivalent of each of two compounds obtained by the addition polymerization was added to the resulting solution in the presence of triethylamine catalyst. Thereafter, the resulting mixture was stirred at room temperature for 5 hours. Thus, ether ester H was obtained. The ether ester H is an ether ester of the formula (2) wherein R¹ and R²: oleyl group (C₁₈H₃₅) and cetyl group (C₁₆H₃₃), R³: C₃H₄, a+b=10 and HLB=8.3.

### First Example

### Preparation and Evaluation of Rubber Composition

Banbury mixer was used. Compounding ingredients excluding sulfur and a vulcanization accelerator were added to a rubber component according to the formulations (parts by mass) shown in Table 1 below, followed by kneading, in a first mixing step (discharge temperature: 160° C.). Sulfur and a vulcanization accelerator were then added to the kneaded material obtained, followed by kneading, in a final mixing step (discharge temperature: 90° C.). Thus, rubber compositions were prepared. The details of each component in Table 1 are as follows.

SBR 1: TUFDENE 4850 (Oil-extended rubber containing 50 parts by mass of oil to 100 parts by mass of rubber polymer. In Table, rubber polymer content is indicated in parentheses) manufactured by Asahi Kasei Corporation

BR: BR150B manufactured by Ube Industries, Ltd.

Carbon black 1: DIABLACK N330 manufactured by Mitsubishi Chemical Corporation

Silica: NIPSIL AQ (BET: 205 m²/g) manufactured by Tosoh Silica Corporation

Silane coupling agent 1: Si75 manufactured by Evonik Degussa

Oil 1: JOMO PROCESS NC140 manufactured by JX Nippon Oil & Sun-Energy Corporation

Zinc flower 1: Zinc Flower #1 manufactured by Mitsui Mining & Smelting Co., Ltd.

Age resister: NOCRAC 6C manufactured by Ouchi Shinko Chemical Industrial Co., Ltd.

Stearic acid: LUNAC S-20 manufactured by Kao Corporation

Processing aid: AKTIPLAST PP manufactured by LANXESS

Sulfur: POWDERED SULFUR manufactured by Tsurumi Chemical Industry Co., Ltd.

Vulcanization accelerator 1: NOCCELER D manufactured by Ouchi Shinko Chemical Industrial Co., Ltd.

Vulcanization accelerator 2: SOXINOL CZ manufactured by Sumitomo Chemical Co., Ltd.

Processability of each rubber composition obtained was evaluated, and using a test piece having a predetermined shape obtained by vulcanizing each rubber composition at 160° C. for 20 minutes, abrasion resistance and tear resistance were evaluated. Each of measurement and evaluation methods is as follows.

Processability: Unvulcanized rubber composition was preheated at 100° C. for 1 minute and torque value after 4 minutes was measured in Mooney unit, using rotorless Mooney measuring instrument manufactured by Toyo Seiki Co., Ltd. according to JIS K6300. Inverse number of the measured value was indicated by an index as the value of Comparative Example 1 being 100. Mooney viscosity is low as the index is large, and this means that processability is excellent.

Abrasion resistance: Abrasion loss was measured under the conditions of load: 40N and slip ratio: 30% according to JIS K6264 using Lamboum abrasion tester manufactured by Iwamoto Seisakusho. Inverse number of the measured value was indicated by an index as the value of Comparative Example 1 being 100. Abrasion loss is small as the index is large, and this means that abrasion resistance is excellent.

Tear resistance: Tear resistance was measured according to JIS K6252. Vulcanized rubber was punched into a crescent shape, and a test piece having a cut of 0.50±0.08 mm formed on the center of depression was prepared. The test piece was subjected to a tear test in a tensile rate of 500 mm/min by a tensile tester manufactured by Shimadzu Corporation, and tear force was measured. The tear force was indicated by an index as the value of Comparative Example 1 being 100. Tear force is high as the index is large, and this means that tear resistance is excellent.

TABLE 1

| Formulations | Com. | Com. | Com. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|
| (parts by mass) | Ex. 1 | Ex. 2 | Ex. 1 | 1 | 2 | 3 | 4 | 5 | 6 | 7 | 8 | 9 | 10 | 11 | 12 |
| SBR 1 | 112.5 | 112.5 | 112.5 | 112.5 | 112.5 | 112.5 | 112.5 | 112.5 | 112.5 | 112.5 | 112.5 | 112.5 | 112.5 | 112.5 | 112.5 |
| | (75) | (75) | (75) | (75) | (75) | (75) | (75) | (75) | (75) | (75) | (75) | (75) | (75) | (75) | (75) |
| BR | 25 | 25 | 25 | 25 | 25 | 25 | 25 | 25 | 25 | 25 | 25 | 25 | 25 | 25 | 25 |
| Carbon black 1 | 10 | 10 | 10 | 10 | 10 | 10 | 10 | 10 | 10 | 10 | 10 | 10 | 10 | 10 | 10 |
| Silica | 80 | 100 | 120 | 80 | 80 | 80 | 100 | 120 | 80 | 80 | 80 | 80 | 80 | 80 | 80 |
| Silane coupling agent 1 | 8 | 10 | 10 | 8 | 8 | 8 | 10 | 10 | 8 | 8 | 8 | 8 | 8 | 8 | 8 |
| Oil 1 | 5 | 10 | 10 | 5 | 5 | 5 | 10 | 10 | 5 | 5 | 5 | 5 | 5 | 5 | 5 |
| Zinc flower 1 | 3 | 3 | 3 | 3 | 3 | 3 | 3 | 3 | 3 | 3 | 3 | 3 | 3 | 3 | 3 |
| Age resister | 2 | 2 | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 | 2 | 2 |
| Processing aid | 5 | 5 | 5 | — | — | — | — | — | — | — | — | — | — | — | — |
| Ether ester A | — | — | — | 5 | 2 | 8 | 5 | 5 | — | — | — | — | — | — | — |
| Ether ester B | — | — | — | — | — | — | — | — | 5 | — | — | — | — | — | — |
| Ether ester C | — | — | — | — | — | — | — | — | — | 5 | — | — | — | — | — |
| Ether ester D | — | — | — | — | — | — | — | — | — | — | 5 | — | — | — | — |
| Ether ester E | — | — | — | — | — | — | — | — | — | — | — | 5 | — | — | — |
| Ether ester F | — | — | — | — | — | — | — | — | — | — | — | — | 5 | — | — |
| Ether ester G | — | — | — | — | — | — | — | — | — | — | — | — | — | 5 | — |
| Ether ester H | — | — | — | — | — | — | — | — | — | — | — | — | — | — | 5 |
| Sulfur | 2 | 2 | 2 | 2 | 2 | 2 | 2 | 2 | 2 | 2 | 2 | 2 | 2 | 2 | 2 |
| Vulcanization accelerator 1 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Evaluation (Index) | | | | | | | | | | | | | | | |
| Processability | 100 | 92 | 84 | 123 | 111 | 129 | 110 | 103 | 123 | 124 | 123 | 124 | 124 | 126 | 124 |
| Abrasion resistance | 100 | 100 | 96 | 112 | 105 | 105 | 108 | 105 | 110 | 109 | 110 | 111 | 112 | 113 | 114 |
| Tear resistance | 100 | 100 | 90 | 118 | 110 | 108 | 108 | 105 | 111 | 126 | 112 | 112 | 104 | 104 | 117 |

The results are shown in Table 1. When the amount of silica added is 80 parts by mass, the improvement effect was recognized in all of processability, abrasion resistance and tear resistance in Examples 1 to 3 and 6 to 12 using the ether ester as compared with Comparative Example 1 using the processing aid comprising the aliphatic metal salt.

When the amount of silica added is 100 parts by mass, the improvement effect was recognized in all of processability, abrasion resistance and tear resistance in Example 4 using the ether ester as compared with Comparative Example 2 using the processing aid comprising the aliphatic metal salt.

When the amount of silica added is 120 parts by mass, the improvement effect was recognized in all of processability, abrasion resistance and tear resistance in Example 5 using the ether ester as compared with Comparative Example 3 using the processing aid comprising the aliphatic metal salt.

### Second Example

### Preparation and Evaluation of Rubber Composition and Tire

According to the formulations (parts by mass) shown in Table 2 below, rubber compositions were prepared in the same manner as in First Example. The details of each component in Table 2 are as follows (The components that are the same as those shown in Table 1 are described above).

SBR 2: SBR 0122 (Unmodified ESBR having Tg=−40° C. Oil-extended rubber containing oil in an amount of 34 parts by mass per 100 parts by mass of the rubber polymer. In the Table, the rubber polymer content is shown in parentheses.) manufactured by JSR Corporation

SBR 3: HPR 350 (Alkoxyl group and amino group end-modified SSBR having Tg=−33° C.) manufactured by JSR Corporation

SBR 4: SE-6529 (Unmodified SSBR having Tg=−4° C.) manufactured by Sumitomo Chemical Co., Ltd.

NR: RSS #3

Carbon black 2: SEAST 3 manufactured by Tokai Carbon Co., Ltd.

Zinc flower 2: ZINC FLOWER #3 manufactured by Mitsui Mining & Smelting Co., Ltd.

Wax: OZOACE 0355 manufactured by Nippon Seiro Co., Ltd.

Silane coupling agent 2: Si69 manufactured by Evonik Degussa

Each rubber composition obtained was used in a tread rubber, and a pneumatic radial tire (tire size: 215/45ZR17) was manufactured by vulcanization molding according to the conventional method. Steering stability, abrasion resistance and low rolling resistance of the test tire obtained were evaluated. Each measurement and evaluation method is as follows.

Steering stability: Four test tires were mounted on a passenger car, and sensory (feeling) evaluation of steering stability by test drivers was performed on a dry road surface. Steering stability was indicated by an index as steering stability of Comparative Example 4 being 100. Dry steering stability is good as the index is large.

Abrasion resistance: Four test tires were mounted on a passenger car, and the car was made to run 10000 km on a dry road surface while rotating the tires right and left every 2500 km. Average value of residual groove depths of four tires after running was indicated by the index as Comparative Example 4 being 100. The residual depth is large as the index is large, and this indicates that abrasion resistance is good.

Low rolling resistance: Rolling resistance of each tire was measured under the conditions of air pressure: 230 kPa, load: 4410N, temperature: 23° C. and speed: 80 km/hour using a rolling resistance measuring drum testing machine. Inverse number of the rolling resistance was indicated by an index as the value of Comparative Example 4 being 100. Rolling resistance is small as the index is large, and this indicates that fuel consumption is excellent.

The results are shown in Table 2. Both abrasion resistance and low rolling resistance could be improved without deteriorating low rolling resistance in Examples 13 to 25 using the ether ester as compared with Comparative Example 4.

TABLE 2

| Formulations | Com. | Ref. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|
| (parts by mass) | Ex. 4 | Ex. 1 | 13 | 14 | 15 | 16 | 17 | 18 | 19 | 20 | 21 | 22 | 23 | 24 | 25 |
| SBR 2 | 93.8 | — | 93.8 | 93.8 | 93.8 | 93.8 | 93.8 | 93.8 | 93.8 | 93.8 | 93.8 | 93.8 | — | 93.8 | 67 |
| | (70) | | (70) | (70) | (70) | (70) | (70) | (70) | (70) | (70) | (70) | (70) | | (70) | (50) |
| SBR 3 | — | — | — | — | — | — | — | — | — | — | — | — | 70 | — | 50 |
| SBR 4 | — | 70 | — | — | — | — | — | — | — | — | — | — | — | — | — |
| NR | 30 | 30 | 30 | 30 | 30 | 30 | 30 | 30 | 30 | 30 | 30 | 30 | 30 | 30 | — |
| Silica | 90 | 90 | 90 | 90 | 90 | 90 | 90 | 90 | 90 | 90 | 90 | 90 | 90 | 60 | 90 |
| Carbon black 2 | 5 | 5 | 5 | 5 | 5 | 5 | 5 | 5 | 5 | 5 | 5 | 5 | 5 | 40 | 5 |
| Oil 1 | 20 | 44 | 20 | 20 | 20 | 20 | 20 | 20 | 20 | 20 | 20 | 20 | 44 | 20 | 27 |
| Ether ester A | — | 5 | 3 | 5 | 8 | — | — | — | — | — | — | — | 5 | 5 | 5 |
| Ether ester B | — | — | — | — | — | 5 | — | — | — | — | — | — | — | — | — |
| Ether ester C | — | — | — | — | — | — | 5 | — | — | — | — | — | — | — | — |
| Ether ester D | — | — | — | — | — | — | — | 5 | — | — | — | — | — | — | — |
| Ether ester E | — | — | — | — | — | — | — | — | 5 | — | — | — | — | — | — |
| Ether ester F | — | — | — | — | — | — | — | — | — | 5 | — | — | — | — | — |
| Ether ester G | — | — | — | — | — | — | — | — | — | — | 5 | — | — | — | — |
| Ether ester H | — | — | — | — | — | — | — | — | — | — | — | 5 | — | — | — |
| Zinc flower 2 | 3 | 3 | 3 | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 | 2 | 2 | 2 |
| Age resister | 2 | 2 | 2 | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 | 2 | 2 | 2 |
| Silane coupling agent 2 | 7 | 7 | 7 | 7 | 7 | 7 | 7 | 7 | 7 | 7 | 7 | 7 | 7 | 5 | 7 |
| Sulfur | 2 | 2 | 2 | 2 | 2 | 2 | 2 | 2 | 2 | 2 | 2 | 2 | 2 | 2 | 2 |
| Vulcanization accelerator 1 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Evaluation (Index) | | | | | | | | | | | | | | | |
| Steering stability | 100 | 102 | 102 | 105 | 106 | 103 | 104 | 105 | 104 | 102 | 104 | 103 | 103 | 102 | 103 |
| Abrasion resistance | 100 | 98 | 105 | 112 | 110 | 113 | 112 | 112 | 114 | 115 | 113 | 114 | 107 | 114 | 105 |
| Low rolling resistance | 100 | 95 | 101 | 101 | 100 | 101 | 101 | 100 | 100 | 101 | 100 | 102 | 102 | 100 | 100 |

### Third Example

### Preparation and Evaluation of Rubber Composition and Tire

According to the formulations (parts by mass) shown in Table 3 below, rubber compositions were prepared in the same manner as in First Example. The details of each component in Table 3 are as follows (The components that are the same as those shown in Tables 1 and 2 are described above).

SBR 5: TUFDENE 1834 manufactured by Asahi Kasei Corporation (Unmodified SSBR having Tg=−68° C. Oil-extended rubber containing oil in an amount of 37.5 parts by mass per 100 parts by mass of the rubber polymer. In the Table, the rubber polymer content is shown in parentheses.)

Oil 2: JOMO PROCESS P200 manufactured by JX Nippon Oil & Sun-Energy Corporation

Each rubber composition obtained was used in a tread rubber, and a pneumatic radial tire (tire size: 195/65R15) was manufactured by vulcanization molding according to the conventional method. Snow performance, low rolling resistance and abrasion resistance of the test tire obtained were evaluated. Evaluation method of snow performance is as follows. Low rolling resistance and abrasion resistance were evaluated in the same manner as in Second Example (However, the low rolling resistance and abrasion resistance are indicated by an index as the value of Comparative Example 5 being 100).

Snow performance: Four test tires were mounted on a passenger car. ABS was operated from 60 km/hour running on snowy road and a braking distance when the speed was reduced to 20 km/hour was measured (average value of n=10). Inverse number of the braking distance was indicated by an index as the value of Comparative Example 5 being 100. Braking distance is short as the index is large, and this indicates that braking performance on snowy road surface is excellent.

The results are shown in Table 3. In the case of comparing the amount of silica in nearly the same amount, both abrasion resistance and snow performance could be improved without deteriorating low rolling resistance in Examples 26 to 35 and 37 to 39 using the ether ester as compared with Comparative Example 5. Even in the case where silica and carbon black were added one half for each, both abrasion resistance and snow performance could be improved without deteriorating low rolling resistance in Example 36 as compared with Comparative Example 6.

TABLE 3

| Formulations | Com. | Com. | Ref. | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|---|
| (parts by mass) | Ex. 5 | Ex. 6 | Ex. 2 | 26 | 27 | 28 | 29 | 30 | 31 | 32 | 33 | 34 | 35 | 36 | 37 | 38 | 39 |
| SBR 5 | 68.8 | 68.8 | — | 68.8 | 68.8 | 68.8 | 68.8 | 68.8 | 68.8 | 68.8 | 68.8 | 68.8 | 68.8 | 68.8 | 82.5 | 96.3 | 55 |
| | (50) | (50) | | (50) | (50) | (50) | (50) | (50) | (50) | (50) | (50) | (50) | (50) | (50) | (50) | (70) | (40) |
| SBR 4 | — | — | 50 | — | — | — | — | — | — | — | — | — | — | — | — | — | — |
| BR | 40 | 40 | 40 | 40 | 40 | 40 | 40 | 40 | 40 | 40 | 40 | 40 | 40 | 40 | 40 | 20 | 40 |
| NR | 10 | 10 | 10 | 10 | 10 | 10 | 10 | 10 | 10 | 10 | 10 | 10 | 10 | 10 | — | 10 | 20 |
| Silica | 70 | 40 | 70 | 70 | 70 | 75 | 70 | 70 | 70 | 70 | 70 | 70 | 70 | 40 | 70 | 70 | 70 |
| Carbon black 2 | 5 | 40 | 5 | 5 | 5 | 5 | 5 | 5 | 5 | 5 | 5 | 5 | 5 | 40 | 5 | 5 | 5 |
| Oil 2 | 15 | 15 | 34 | 15 | 15 | 15 | 15 | 15 | 15 | 15 | 15 | 15 | 15 | 15 | 15 | 8 | 20 |
| Ether ester A | — | — | 5 | 3 | 5 | 8 | — | — | — | — | — | — | — | 5 | 5 | 5 | 5 |
| Ether ester B | — | — | — | — | — | — | 5 | — | — | — | — | — | — | — | — | — | — |
| Ether ester C | — | — | — | — | — | — | — | 5 | — | — | — | — | — | — | — | — | — |
| Ether ester D | — | — | — | — | — | — | — | — | 5 | — | — | — | — | — | — | — | — |
| Ether ester E | — | — | — | — | — | — | — | — | — | 5 | — | — | — | — | — | — | — |
| Ether ester F | — | — | — | — | — | — | — | — | — | — | 5 | — | — | — | — | — | — |
| Ether ester G | — | — | — | — | — | — | — | — | — | — | — | 5 | — | — | — | — | — |
| Ether ester H | — | — | — | — | — | — | — | — | — | — | — | — | 5 | — | — | — | — |
| Zinc flower 2 | 3 | 3 | 3 | 3 | 3 | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 | 2 | 2 | 2 | 2 | 2 |
| Age resister | 3 | 3 | 3 | 3 | 3 | 3 | 3 | 3 | 3 | 3 | 3 | 3 | 3 | 3 | 3 | 3 | 3 |
| Wax | 2 | 2 | 2 | 2 | 2 | 2 | 2 | 2 | 2 | 2 | 2 | 2 | 2 | 2 | 2 | 2 | 2 |
| Silane coupling agent 2 | 6 | 3 | 6 | 6 | 6 | 6 | 6 | 6 | 6 | 6 | 6 | 6 | 6 | 3 | 6 | 6 | 6 |
| Sulfur | 2 | 2 | 2 | 2 | 2 | 2 | 2 | 2 | 2 | 2 | 2 | 2 | 2 | 2 | 2 | 2 | 2 |
| Vulcanization accelerator 1 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Evaluation (Index) | | | | | | | | | | | | | | | | | |
| Snow performance | 100 | 99 | 97 | 101 | 104 | 107 | 104 | 101 | 102 | 103 | 104 | 103 | 103 | 103 | 105 | 103 | 106 |
| Low rolling resistance | 100 | 98 | 92 | 100 | 101 | 100 | 101 | 101 | 101 | 101 | 101 | 100 | 103 | 101 | 101 | 100 | 100 |
| Abrasion resistance | 100 | 105 | 98 | 112 | 108 | 106 | 108 | 108 | 108 | 110 | 110 | 110 | 105 | 112 | 106 | 105 | 110 |

Some embodiments of the present invention are described above, but those embodiments are merely shown as examples and are not intended to limit the scope of the invention. Those embodiments can be carried out in other various forms, and various omissions, replacement and changes can be made in a range that does not deviate the gist of the invention. Those embodiments and their omissions, replacement and changes are included in the scope and gist of the invention, and additionally included in the inventions recited in the scope of claims and their equivalent scopes.

1. A rubber composition for a tire comprising
a rubber component comprising diene rubber,
silica and
an ether ester represented by the following formula (1): 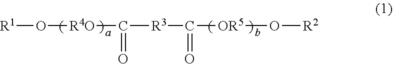
wherein R¹ and R² each independently represent a hydrocarbon group having from 8 to 30 carbon atoms, R³ represents a hydrocarbon group having from 1 to 30 carbon atoms, R⁴ and R⁵ each independently represent an alkylene group having from 2 to 4 carbon atoms, a and b each independently represent an average number of moles of oxyalkylene groups added, and 60 mass % or more of (R⁴O)ₐ and (OR⁵)_{b} comprises an oxyethylene group.

2. The rubber composition for a tire according to claim 1, comprising 100 parts by mass of the rubber component, from 20 to 120 parts by mass of the silica and from 1 to 10 parts by mass of the ether ester.

3. The rubber composition for a tire according to claim 1, wherein the rubber component contains styrene-butadiene rubber having a glass transition temperature of from −70 to −20° C.

4. The rubber composition for a tire according to claim 3, wherein the glass transition temperature of the styrene-butadiene rubber is from −50 to −25° C.

5. The rubber composition for a tire according to claim 3, wherein 100 parts by mass of the rubber component comprise from 50 to 100 parts by mass of the styrene-butadiene rubber and from 0 to 50 parts by mass of natural rubber and/or synthetic isoprene rubber.

6. The rubber composition for a tire according to claim 1, wherein the rubber component contains styrene-butadiene rubber having a glass transition temperature of from −70 to −20° C. and butadiene rubber.

7. The rubber composition for a tire according to claim 6, wherein the glass transition temperature of the styrene-butadiene rubber is −70° C. or more and less than −50° C.

8. The rubber composition for a tire according to claim 6, wherein 100 parts by mass of the rubber component comprise from 40 to 70 parts by mass of the styrene-butadiene rubber, from 20 to 50 parts by mass of the butadiene rubber and from 0 to 30 parts by mass of natural rubber and/or synthetic isoprene rubber.

9. The rubber composition for a tire according to claim 3, wherein the styrene-butadiene rubber contains modified styrene-butadiene rubber having incorporated therein a functional group containing oxygen atom and/or nitrogen atom.

10. A pneumatic tire having a rubber part comprising the rubber composition according to claim 1.

11. A pneumatic tire having a rubber part comprising the rubber composition according to claim 6 and is an all-season tire.

12. The pneumatic tire according to claim 10, wherein the rubber part is tread rubber.
